(19) United States
(12) Patent Application Publication
(10) Pub. No.: US 2009/0037476 A1
(43) Pub. Date: Feb. 5, 2009

(54) Method for Georeferenced Representation of Data of an Area of Measurement Measured by Means of Ground Detectors, and Detectors for the Same

(76) Inventor: Jens KUHNER, Reutlingen (DE)

Correspondence Address: MARK D. SARALINO (GENERAL);RENNER, OTTO, BOISSELLE & SKLAR, LLP, 1621 EUCLID AVENUE, NINETEENTH FLOOR, CLEVELAND, OH, 44115-2191, US

(21) Appl. No.: 12/183,126

(22) Filed: Jul. 31, 2008

(30) Foreign Application Priority Data
Aug. 2, 2007 (EP) 07 015 136.0

(51) Int. Cl. G06F 17/30

(52) U.S. Cl. 707/104.1; 707/E17.018

(57) ABSTRACT

A method for the representation in a computer unit with a display unit of detected metal objects that were detected by means of one or a plurality of ground detectors, for example metal detectors and/or ferrous metal detectors, and suitable detectors for the application of the method. The measured data of an examined area of measurement measured by a detector at certain positions are stored in conjunction with the position in question and, from the data of identified detected objects, coherent data structures with a certain similar measuring intensity associated with said data are generated that are then assigned a georeference of a georeference system. By means of a graphic information system (GIS), the georeferenced coherent data structures in the form of polygon courses and/or filled polygon areas are linked with the data of an earth surface image, and the georeferenced coherent data structures are displayed superimposed on the earth surface image.

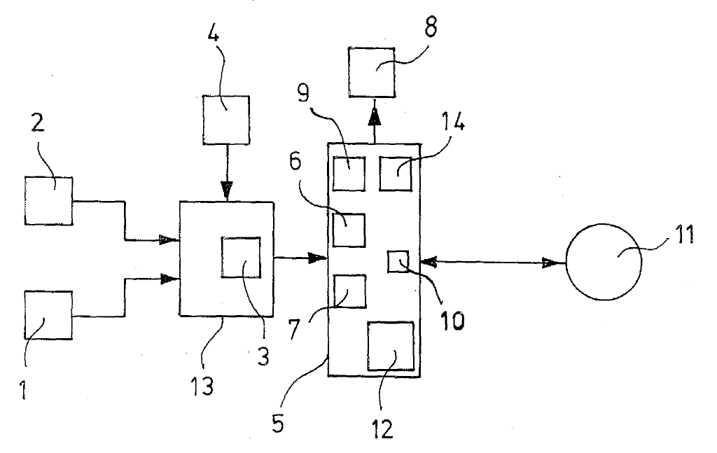

### CROSS-REFERENCE TO RELATED APPLICATION

The present application claims priority under 35 U.S.C. §119 to European Patent Application No. 07 015 136.0, filed on Aug. 2, 2007, the entire disclosure of which is incorporated herein by reference.

### TECHNICAL FIELD OF THE INVENTION

The invention relates to a method for the graphic representation in a computer unit with a display unit of objects of an area of measurement that were detected by means of one or several ground detectors, and a ground detector with an appropriate computer unit for the application of the method. In this context, ground detector refers to metal or ferrous metal detectors for locating metal objects, and also to ground radar detectors for detecting any kind of object that can be detected.

### DESCRIPTION OF THE RELATED ART

Detectors for finding objects, preferably for locating metallic, ferromagnetic, or other foreign bodies in the ground or in water are known. Metal and ferrous metal detectors make use of local distortions of the geomagnetic field caused by ferromagnetic or other metallic foreign bodies to locate these bodies while a ground radar, known as EMR, GPR, or RES, uses anomalies in a reflected electromagnetic radiation caused by foreign bodies made of any kind of material to locate the same. Depending on their size, the material of which they are made, and their magnetic condition, such foreign bodies can be located at great depths.

When probing areas, i.e. in so-called field measurements, with metal and ferrous metal detectors, for example, a marked area of measurement whose surface is divided into measuring tracks is covered on foot or by vehicle in order to detect metal objects. The measurements are taken at certain regular intervals in terms of time or location along the measuring tracks, and the measured data, associated with the measuring position in question, are recorded as data that form a profile line of the measuring tracks for the purpose of permitting a subsequent evaluation and interpretation. Nowadays, it is common to store the data electronically for documentation purposes and a subsequent computer-based evaluation.

When arranged side by side, the individual profile lines result in a complete chart of the area of measurement. Such a representation of the results of measurement lacks clarity and its interpretation requires great experience.

In view of the aforementioned shortcomings, there is a strong need in the art for a manner whereby it is possible to represent clearly the data of the field measurement automatically and in a georeferenced way.

### SUMMARY OF THE INVENTION

According to an aspect of the invention, a method is provided for graphically representing in a computer unit with a display unit objects of an area of measurement that were detected by means of one or a plurality of ground detectors. The method includes storing each measured datum of an examined area of measurement measured by a detector with its position, combining in data groups the data of identified detected objects that are associated with said object, generating coherent data structures with a certain similar measuring intensity from the data associated with each of the identified detected objects, assigning at least one georeference of a georeference system to the data or to the coherent data structures associated with a detected object, storing the coherent data structures with a certain similar measuring intensity, arranged in a given sequence, in a data format suitable for further processing, and linking the georeferenced coherent data structures to the data of an earth surface image in a graphic information system (GIS), and displaying the earth surface image with the georeferenced coherent data structures on the display unit of the computer unit as polygon courses and/or filled polygon areas.

According to a particular aspect, isolines are formed from the data for generating the coherent data structures.

According to another aspect, for integrating the georeferenced coherent data structures, followed by their display, the generated data structure with measured data of lower value is displayed first in the graphic information system.

In accordance with another aspect, the position data of the measuring points are displayed in the sequence of their detection, linked to the georeferenced polygon courses and/or filled polygon areas, and in the form of a continuous series of lines.

According to yet another aspect, the georeference is associated with a group of data.

According to another aspect of the invention, a ground detector with a computer unit for representing detected objects is provided. Data of equal measuring intensity are shown as coherent data structures in the form of polygon courses and/or polygon areas, wherein at least one georeference of a georeference system is assigned to the data of the coherent data structures, and wherein the georeferenced polygon courses and/or polygon areas are displayed superimposed on an image of the earth surface. The computer unit includes at least a first storage device that stores the measured data of each detector and each related detector position in association with each other, a first program module that generates coherent data structures for an identified detected object from data of equal measuring intensity, a second program module that assigns a georeference to the data or the coherent data structures, a second storage device that stores the coherent data structures of equal measuring intensity arranged in a given sequence in a data format that is suitable for further processing, a display unit that displays the georeferenced coherent data structures superimposed on an earth surface image, and a graphic information system that links the georeferenced coherent data structures with the data of the earth surface image and displays them as polygon courses and/or polygon areas superimposed on the earth surface image.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF THE DRAWING

FIGURE is a schematic block diagram of an exemplary embodiment of the present invention.

### DETAILED DESCRIPTION OF THE INVENTION

Below, the invention is described in detail with reference to a combined metal/ferrous metal detector. Additional characteristics of the invention are given in the attached drawing and in the description of the embodiment in conjunction with the claims. In different implementations of the invention, the individual characteristics may be implemented individually or in combinations of several.

In the method according to the invention, every datum of an examined area of measurement that was measured by means of one or a plurality of ground detectors, for example metal or ferrous metal detectors, is first stored electronically along with its position. Then the data associated with identified measured objects are grouped, and coherent data structures with data of a certain similar measurement intensity are generated from the data associated with the measured object in question. At least one georeference of a georeference system that preferably corresponds to the geographic location data of the identified measured object is assigned to the individual stored data and the generated coherent data structures. Then, the coherent data structures with a certain similar measurement intensity for one identified measured object are stored again in a given sequence, a suitable data format being selected for the further processing of the data. Finally, the georeferenced coherent data structures are linked with the data of an earth surface image in a graphic information system and are represented on a display unit of the computer unit. Here, for the purpose of a graphic representation of the detected metal objects superimposed on the area of measurement, the georeferenced coherent data structures are shown superimposed on the earth surface image as polygonal courses and/or filled-polygon areas.

In the method proposed by the invention, the data measured by a detector can either be stored directly in a computer unit that later performs a computer-based evaluation and produces a display of the field measurement, or in an intermediate storage device, for example a data logger, that transfers the measured data to a suitable computer unit after the field measurement. As computer unit, a PDA, a laptop, or a desktop PC may be used, for example.

Already during detection, the at least one georeference for the data can be stored with the measured data, or it can be generated later by being linked with associated stored or otherwise recorded measuring positions as well as measuring positions that were calculated on the basis of a known starting position. A satellite navigation system like GPS, for example, is especially well suited for the fully automatic determination of location data. Such a navigation system can be connected with the electronic evaluation system of the detector that transfers the individual data in conjunction with the momentary location data to a storage system, for example a data logger.

With the help of the data, detected metal objects are identified and, as data groups, the data are associated with an identified detected object. In doing so, the data whose measuring positions are arranged around a center formed by the identified detected object and have a certain similar measuring intensity, are collected in a coherent data structure. Such a structure can be represented as a polygon course or polygon area on a display unit of the evaluating computer unit, for example. Expediently, different colors are assigned to the polygon courses or areas of different measuring intensity, preferably with the color intensity increasing with increasing measuring intensity.

In a graphic information system of the computer unit, the georeferenced coherent data structures are linked with the data of an earth surface image and then displayed. For this purpose, the polygon courses or areas of a certain measuring intensity with the associated positions are superimposed sequentially upon the same position on the image of the earth surface. The sequence of the superimposition plays an important role, at least with a polygon area filled with color. During the display, such polygon areas are arranged one on top of the other in the order of increasing measuring intensity and on top of the earth surface image because the coherent data structures cover a smaller surface area with increasing measuring intensity. If the order were reversed, the larger polygon areas would cover the smaller polygon areas. Here, it is important that the coherent data structures are stored in a given sequence and have a data format that can be read by the graphic information system. Coherent data structures that are associated with different identified detected objects and exhibit a comparable measuring intensity can also be stored as a combined, overlapping data structure.

The integration of the polygon courses or polygon areas in a graphic information system (GIS) with the data of an earth surface image can be performed in a simple way, for example with Google Earth views by means of KML, the Google Earth file format. Like most other viewers, Google Earth is not capable of handling a multitude of individual points. Usually, such viewers are only able to draw lines or areas. For generating the coherent data structures it is therefore desirable to form isolines and iso-areas that can be imported into such a graphic information system. Suitable algorithms are known under the names of “Marching Cubes” or the 2-D equivalent “Marching Squares” and are described in the patents U.S. Pat. No. 4,710,876, U.S. Pat. No. 4,885,688, and U.S. Pat. No. 7,006,106, for example (the entire disclosures of which are incorporated herein by reference).

In a similar way, the area of measurement with its measuring tracks can be linked with the data of the earth surface image and can also be displayed in the graphic information system. In that case, they are displayed first in the graphic information system, followed on different levels by the georeferenced coherent data structures of a certain measuring intensity, with the data structures with the next-lower data values being displayed first in the graphic information system. For this purpose, the positional data of the measuring points are preferably linked with the georeferenced polygon courses and/or filled polygon areas in the sequence of their detection and displayed as a continuous series of lines. Also, an implementation of the method according to the invention is preferred where the georeference is associated with a group of data.

In the ferrous metal or metal detector according to the invention, with a computer unit for representing detected metal objects during the application of the method described above, where data of equal measuring intensity are shown as coherent data structures in the form of polygon courses and/or polygon areas, where at least one georeference of a georeference system is assigned to the data, and where the individual georeferenced polygon courses and/or polygon areas are displayed superimposed on an image of the earth's surface, the computer unit includes at least the following items: a first storage device that stores the data of the individual detectors and of the individual detector position; a first program module that generates coherent data structures for an identified detected object from data of equal measuring intensity; a second program module that assigns a georeference to the data or the coherent data structures; a second storage device that stores the coherent data structures of equal measuring intensity arranged in a given sequence in a data format that is suitable for further processing; a display unit that displays the georeferenced coherent data structures superimposed on an earth surface image; and a graphic information system that links the georeferenced coherent data structures with the data of the earth surface image and displays them as polygon courses and/or polygon areas superimposed on the earth surface image.

The data of the earth surface image can be entered either directly from the internet, or can be stored first in a storage device.

Referring to the FIGURE, one ferrous metal detector 1 and one metal detector 2 each are coupled with a first storage device 3 (e.g., computer memory) that is part of a PDA 13 operated as a data logger. The detectors 1, 2 transmit their measured data to the PDA 13 that also stores the positional data of the detectors 1, 2 associated with the measured data. For this purpose, the PDA 13 is connected with a satellite navigation system 4 (e.g., GPS) that supplies the positional data of the detectors 1, 2.

For a later computer-based evaluation, the data stored in the first storage device 3 and their associated positional data of the detectors 1, 2 are transferred to a personal computer 5 that generates coherent data structures with a certain similar measuring intensity from the measured data and stores them, arranged in a given sequence and in a data format that is suitable for further processing, in a second storage device 6 (e.g., computer memory) that is a component of the personal computer 5. For this purpose, the personal computer 5 has a first program module 7.

For the positionally precise visualization on a display unit 8, for example a computer screen connected with the personal computer 5, a second program module 9 associates a georeference with the coherent data structures in the form of polygon courses and/or polygon areas with the help of the positional data that were stored in association with the measured data.

In addition, the personal computer 5 has an interface 10 for the internet 11 where it downloads earth surface images and then stores them in a storage device 12. By means of a graphic information system 14, preferably Google Earth, the data of the earth surface image are displayed on the screen 8, and the georeferenced coherent data structures are superimposed on said data.

The first and second program modules 7, 9 may be programs in virtually any computer language or format designed to carry out the functions described herein. The precise computer code is not germane to the present invention and will be readily apparent to one having ordinary skill in the art of computer programming in view of the disclosure herein. Consequently, further detail has been omitted for sake of brevity. The first and second program modules 7, 9 are stored in a computer readable medium (e.g., RAM, ROM, magnetic or optical disk, etc.) and, when executed by the personal computer 5, cause the computer 5 to carry out the functions described herein.

Although the invention has been shown and described with respect to certain preferred embodiments, it is obvious that equivalents and modifications will occur to others skilled in the art upon the reading and understanding of the specification. The present invention includes all such equivalents and modifications, and is limited only by the scope of the following claims.

1. A method for graphically representing in a computer unit with a display unit objects of an area of measurement that were detected by means of one or a plurality of ground detectors, comprising:
storing each measured datum of an examined area of measurement measured by a detector with its position,
combining in data groups the data of identified detected objects that are associated with said object,
generating coherent data structures with a certain similar measuring intensity from the data associated with each of the identified detected objects,
assigning at least one georeference of a georeference system to the data or to the coherent data structures associated with a detected object,
storing the coherent data structures with a certain similar measuring intensity, arranged in a given sequence, in a data format suitable for further processing, and
linking the georeferenced coherent data structures to the data of an earth surface image in a graphic information system (GIS), and displaying the earth surface image with the georeferenced coherent data structures on the display unit of the computer unit as polygon courses and/or filled polygon areas.

2. The method according to claim 1, wherein isolines are formed from the data for generating the coherent data structures.

3. The method according to claim 1, wherein, for integrating the georeferenced coherent data structures, followed by their display, the generated data structure with measured data of lower value is displayed first in the graphic information system.

4. The method according to claim 1, wherein the position data of the measuring points are displayed in the sequence of their detection, linked to the georeferenced polygon courses and/or filled polygon areas, and in the form of a continuous series of lines.

5. The method according to claim 1, wherein the georeference is associated with a group of data.

6. A ground detector with a computer unit for representing detected objects, wherein data of equal measuring intensity are shown as coherent data structures in the form of polygon courses and/or polygon areas, and wherein at least one georeference of a georeference system is assigned to the data of the coherent data structures, and wherein the georeferenced polygon courses and/or polygon areas are displayed superimposed on an image of the earth surface, with the computer unit including at least the following:
a first storage device that stores the measured data of each detector and each related detector position in association with each other,
a first program module that generates coherent data structures for an identified detected object from data of equal measuring intensity,
a second program module that assigns a georeference to the data or the coherent data structures,
a second storage device that stores the coherent data structures of equal measuring intensity arranged in a given sequence in a data format that is suitable for further processing,
a display unit that displays the georeferenced coherent data structures superimposed on an earth surface image, and
a graphic information system that links the georeferenced coherent data structures with the data of the earth surface image and displays them as polygon courses and/or polygon areas superimposed on the earth surface image.

7. The ground detector with the computer unit according to claim 6, wherein isolines are formed from the data for generating the coherent data structures.

8. The ground detector with the computer unit according to claim 6, wherein, for integrating the georeferenced coherent data structures, followed by their display, the generated data structure with measured data of lower value is displayed first in the graphic information system.

9. The ground detector with the computer unit according to claim 6, wherein the position data of the measuring points are displayed in the sequence of their detection, linked to the georeferenced polygon courses and/or filled polygon areas, and in the form of a continuous series of lines.

10. The ground detector with the computer unit according to claim 6, wherein the georeference is associated with a group of data.
